(19) United States
(12) Patent Application Publication
(10) Pub. No.: US 2021/0042723 A1
(43) Pub. Date: Feb. 11, 2021

(54) SYSTEMS AND METHODS FOR DYNAMIC ACCOUNT MANAGEMENT USING MACHINE LEARNING

(71) Applicant: Capital One Services, LLC, McLean, VA (US)

(72) Inventors: Austin WALTERS, Savoy, IL (US); Jeremy GOODSITT, Champaign, IL (US); Galen RAFFERTY, Mahomet, IL (US); Mark WATSON, Sedona, AZ (US); Anh TRUONG, Champaign, IL (US); Vincent PHAM, Champaign, IL (US); Reza FARIVAR, Champaign, IL (US)

(73) Assignee: Capital One Services, LLC, McLean, VA (US)

(21) Appl. No.: 16/536,752

(22) Filed: Aug. 9, 2019

(51) Int. Cl. G06Q 20/10; G06N 20/00; G06N 3/08; G06Q 40/02

(52) U.S. Cl. CPC G06Q 20/102; G06Q 40/025; G06N 3/08; G06N 20/00

(57) ABSTRACT

Various embodiments of the present disclosure relate to dynamically managing individual digital accounts using machine learning, and to generating and tuning machine learning models for predicting, evaluating, and managing individual digital account activity. Computer-implemented methods disclosed herein may comprise accessing a data repository including a plurality of groups, selecting a group for a customer, based on at least one identifying characteristic of the customer, training a machine learning model using behavior of the customer and the selected group, generating a predictive simulation of a situation for the customer based on the trained machine learning model, and managing one or more accounts of the customer based on the machine learning model, the predictive simulation, and at least one outstanding account balance.

### TECHNICAL FIELD

Various embodiments of the present disclosure relate generally to dynamically managing individual digital accounts using machine learning, and more specifically to generating and tuning machine learning models for predicting, evaluating, and managing individual digital account activity.

### BACKGROUND

Predicting, evaluating, and managing digital account activity (e.g., bank account, credit account, or loan repayment account activity) may present various challenges. Account activity may fluctuate with, e.g., changes in an account owner's needs, anticipated events, unforeseen events, market health, and/or shifts in account holder circumstances.

Manually managing accounts (e.g., account balances, payments, etc.), or using standard automated account management systems (e.g., to pay bills, pay loans, or move a set balance from one account to another) may present challenges due to the amount and changeability of the information relevant to account management. Funds available to pay bills, pay loans, etc. may fluctuate over time in ways that may not be accounted for in manual or standard automatic account management systems and methods. Some types of information may be inaccessible, inconvenient, or simply unavailable to an individual managing one or more accounts. For example, predicting unforeseen circumstances such as medical emergencies, unexpected travel needs, natural disasters, and other circumstances which may require expenditure of money to resolve may be difficult or impossible.

Additionally, maximizing the speed and efficiency of account balancing and resolution may be challenging. Manual account management may include, e.g., underestimating loan repayment or bill payment capabilities to avoid risks, such as overdrawing accounts or depleting emergency funds. Moreover, traditional methods of account management may render dynamic strategies (e.g., frequent or periodic changes in bill or loan payment amounts) time-consuming, impractical, or impossible.

The present disclosure is directed to addressing one or more of these above-referenced challenges. The background description provided herein is for the purpose of generally presenting the context of the disclosure. Unless otherwise indicated herein, the materials and information described in this section are not prior art to the claims in this application and are not admitted to be prior art, or suggestions of prior art, by inclusion in this section.

### SUMMARY

According to some aspects of the present disclosure, computer-implemented methods for account management are disclosed. Aspects of any embodiment described herein may be combined with aspects of any other embodiment disclosed herein. In one aspect, a computer-implemented method of deducting funds from a digital account is disclosed. The method may include accessing a data repository including a plurality of groups, wherein each group includes a plurality of identified customers and one or more characteristics of each identified customer. The method may further include selecting a group for an enrolled customer, based on at least one identifying characteristic of the enrolled customer, training a machine learning model using financial behavior of the enrolled customer and the selected group, generating a predictive simulation of a financial situation for the enrolled customer based on the trained machine learning model, calculating a periodic payment for the enrolled customer based on the machine learning model, the predictive simulation, and an outstanding loan balance of the enrolled customer, and automatically deducting the calculated periodic payment from a digital account of the enrolled customer.

In some embodiments, the financial behavior of the enrolled customer may include one of a spending habit of the enrolled customer, or a purchase made by the enrolled customer. In some embodiments, generating the predictive simulation of the financial situation for the enrolled customer includes predicting a financial impact of a trigger event on the enrolled customer. In some embodiments, the method may further include predicting the financial impact of the trigger event on the enrolled customer during a period of time including at least three months. In some embodiments, the method may further includes automatically applying the periodic payment deducted from the digital account of the enrolled customer to an account requiring payment. In some embodiments, the account requiring payment is a loan repayment account.

In some embodiments, the method may further include receiving new financial behavior of the enrolled customer, recalculating a periodic payment for the enrolled customer based on the new financial behavior, automatically deducting the recalculated periodic payment from the digital account of the enrolled customer, and automatically applying the recalculated deducted periodic payment to a balance requiring payment. In some embodiments, each of the plurality of groups may include customers having one or more characteristics in common with other customers in the group, and the one or more characteristics of each customer may include a transaction history pattern, a credit score range, an account balance range, an account type, a geographic location, an income range, or an age range. In some embodiments, the machine learning model includes one of a recurring neural network or a convolutional neural network.

In one aspect, a computer-implemented method of deducting funds from a digital account may include populating a data repository with data identifying a plurality of customers and one or more characteristics of each customer, sorting the plurality of customers into a plurality of groups based on the one or more characteristics of each customer, training a machine learning model to generate predicted financial behavior common to customers in each of the plurality of groups, assigning an enrolled customer having a digital customer account to a group based on at least one identifying characteristic of the enrolled customer, tuning the machine learning model using actual financial behavior of the enrolled customer, generating a predictive simulation of a financial situation for the enrolled customer based on the adjusted machine learning model, calculating a periodic payment for the enrolled customer towards an outstanding loan balance based on the adjusted machine learning model, the predictive simulation, and the outstanding loan balance, and automatically deducting the periodic payment from the digital customer account and applying it to the outstanding loan balance.

In some embodiments, assigning the enrolled customer to the group may include identifying a commonality between the at least one characteristic of the enrolled customer and one or more characteristics of other customers in the group. In some embodiments, the commonality may include one of a similar transaction history, a similar credit score, a similar average account balance, an account type, a similar geographic location, a similar income, or a similar age. In some embodiments, the at least one identifying characteristic of the enrolled customer may include a transaction history.

In some embodiments, the method may further include receiving a request from the enrolled customer to calculate the periodic payment for the enrolled customer towards the outstanding loan balance. In some embodiments, the method may further include receiving information regarding a trigger event for the enrolled customer, and automatically recalculating a periodic payment for the enrolled customer towards the outstanding loan balance, based on the trigger event. In some embodiments, the predictive simulation of the financial situation for the enrolled customer may include simulating a financial impact of a trigger event for the enrolled customer, and the trigger event may include an unexpected decrease in funds in the digital customer account, or an unexpected requirement for more funds from the digital customer account from a third party.

In some embodiments, the predicted financial behavior common to customers in at least one of the plurality of groups may include predicted financial behavior based on a time of year. In some embodiments, the method may include receiving information regarding a trigger event for the enrolled customer, automatically recalculating a periodic payment for the enrolled customer towards the outstanding loan balance, and sending a message to the enrolled customer describing the trigger event and the recalculated periodic payment. In some embodiments, the step of sorting the plurality of customers into the plurality of groups based on the one or more characteristics of each customer may include executing an unsupervised clustering algorithm.

In one aspect, a non-transitory computer-readable medium is disclosed. The non-transitory computer-readable medium may store instructions that, when executed by one or more processors of a computer system, cause the one or more processors to perform operations including: populating a data repository with a plurality of groups, a plurality of customers associated with each of the plurality of groups, and one or more characteristics of each customer, training a machine learning model to generate predicted financial behavior common to customers in each of the plurality of groups, assigning an enrolled customer having a digital customer account to a group based on at least one identifying characteristic of the enrolled customer, tuning the machine learning model using actual financial behavior of the enrolled customer, calculating a periodic payment for the enrolled customer towards an outstanding loan balance based on the adjusted machine learning model and the outstanding loan balance, and automatically applying the period payment from the digital customer account to the outstanding loan balance.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and, together with the description, serve to explain the principles of the disclosed embodiments.

FIG. 1 illustrates, in schematic form, an exemplary system according to the present disclosure.

FIG. 2 illustrates, in schematic form, an exemplary flow diagram according to the present disclosure.

FIG. 3 depicts, in flow chart form, steps in a method for managing an account using a machine learning model, according to aspects of the present disclosure.

FIG. 4 depicts, in flow chart form, steps in a method for training a machine learning model and managing an account using the machine learning model, according to aspects of the present disclosure.

FIG. 5 depicts, in flow chart form, steps in a method for tuning a machine learning model, dynamically manage an account using the machine learning model, and output information according to aspects of the present disclosure.

FIG. 6 is a block diagram depicting an exemplary computing device that may execute techniques presented herein.

There are many embodiments described and illustrated herein. The present disclosure is neither limited to any single aspect nor embodiment thereof, nor to any combinations and/or permutations of such aspects and/or embodiments. Each of the aspects of the present disclosure, and/or embodiments thereof, may be employed alone or in combination with one or more of the other aspects of the present disclosure and/or embodiments thereof. For the sake of brevity, many of those combinations and permutations are not discussed separately herein.

### DETAILED DESCRIPTION

The terminology used in this disclosure is to be interpreted in its broadest reasonable manner, even though it is being used in conjunction with a detailed description of certain specific examples. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “using” means “using at least in part.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as “about,” “approximately,” “substantially,” and “generally,” are used to indicate a possible variation of ±10% of a stated or understood value, unless stated otherwise.

The term “group” as used herein may refer to any plurality of entities, individuals, records, data entries, etc. that may be characterized by one or more variables, and that have one or more variables in common with one another. Variables that characterize a member of a group may include, for example, any feature that describes the member of the group. Non-exclusive examples of variables that may characterize a member of a group may include a geographic location, a time period, a financial bracket, an income or income range, a transaction history, a particular event (e.g., birth, death, marriage, matriculation, graduation, promotion, retirement, hiring, dismissal from employment, bankruptcy etc.), a particular action (e.g., moving, buying, selling, taking out a loan, defaulting on a loan, etc.), a spending habit or pattern (e.g., a weekly, monthly, seasonal, or annual spending habit or pattern), a type of ownership (e.g., ownership of real property, a vehicle, a business, etc.), affiliation with an organization (e.g., being a member, customer, client, partner, or otherwise affiliated with, a company, organization, political group, bank, lender, etc.), a tax bracket, a place of employment, a type of employment, a gain or a loss (e.g., a financial gain or a financial loss), and the like.

Aspects of the present disclosure are directed to training or tuning a machine learning model to assist in automatically managing one or more digital accounts. Further aspects of the present disclosure are directed to the automatic management of digital accounts. For example, aspects of the present disclosure may be directed to training or tuning a machine learning model using data from a plurality of sources (e.g., customers, individuals, or users), and, using the machine learning model, automatically managing one or more digital accounts of a customer. In some embodiments, automatically managing one or more digital accounts of a customer may include automatically determining a suitable periodic payment and/or a suitable interval or period for a recurring payment to deduct from or pay towards an account, and/or automatically deducting or making the periodic/recurring payment. In some embodiments, automatically managing the one or more digital accounts may include dynamically determining the suitable periodic payment and/or the suitable interval or period using, e.g., periodic new information to tune the machine learning model or recalculate the payment. Advantageously, aspects of the present disclosure may assist in improving account management by, e.g., maximizing payments that are required towards outstanding balances while adapting to an account holder's transactional habits (e.g., accounting for weekly/monthly/seasonal spending habits) and minimizing risks to an account holder (e.g., a risk of overdrawing, a risk of having too few funds to cover emergency expenditures, etc.).

While aspects of the present disclosure may be described with respect to deducting funds from an account and/or making payments towards an account, it is contemplated that aspects of the present disclosure also may be applicable to any type of account management (e.g., budgeting, balancing accounts, apportioning income to accounts, making a decision as to whether to create a new account, credit decisions, etc.).

The foregoing description of advantages provided by systems and methods of the present disclosure is exemplary, and does not foreclose the existence of many other advantages that aspects of the present disclosure may provide. Reference will now be made to the figures accompanying the present disclosure.

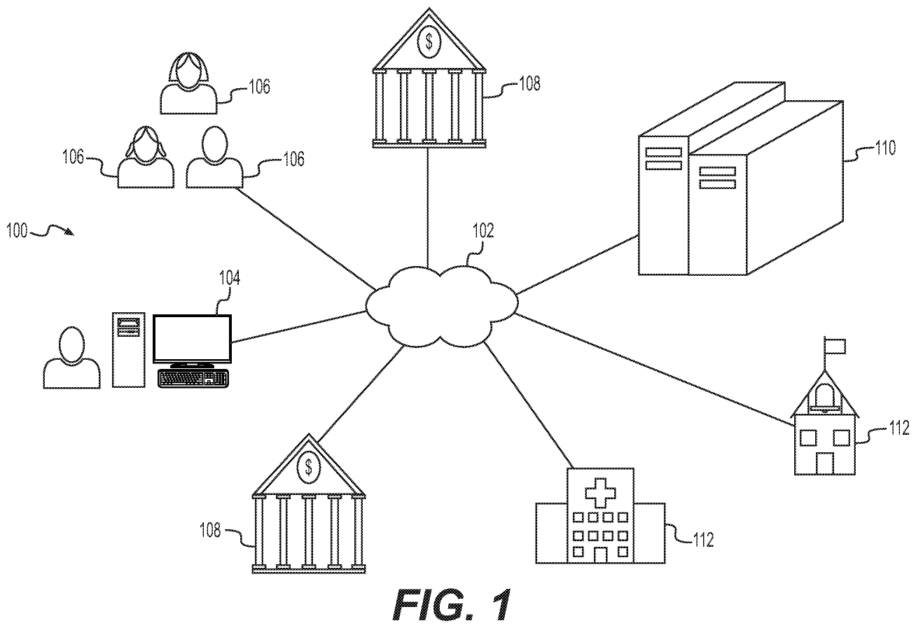

FIG. 1 illustrates an exemplary system 100, which may encompass aspects of the embodiments disclosed herein, and/or in which steps of methods disclosed herein may be performed. System 100 may include a network 102, which may connect a customer 104, a plurality of users 106, account institutions 108, server system 110, and service providers 112.

System 100 may include computer hardware, computer software, and/or combinations of both associated with each aspect of system 100. Aspects of system 100 may be located in similar or disparate locations. In some instances, for example, customer 104, users 106, account institutions 108, server system 110, and service providers 112 may each be in separate physical locations (e.g., on separate computer systems, in separate databases, and/or in separate geographic locations). In some instances, for example, multiple users 106, multiple account institutions 108, multiple server systems 110, and multiple service providers 112 may be located in separate geographical locations. In further instances, two or more of the aspects of system 100 may be located in the same physical location, e.g., on the same computer, in the same database, or in the same geographic location. For example, an account institution 108 may house a server system 110 at a single geographic location.

Aspects and components of system 100 may be connected by wired or wireless connections. Some such connections are represented by the straight lines connecting some of the aspects of system 100 in FIG. 1; however, it is contemplated that additional or different wired or wireless connections may exist between aspects of system 100. Wired or wireless connections between aspects of system 100 may include, for example, connections within a single machine, or wired or wireless connections over a local area network or a wide area network (e.g., the Internet). Furthermore, while aspects of system 100 are shown in FIG. 1, it is contemplated that system 100 may include more components, fewer components, and/or alternate or additional configurations of the depicted components.

Network 102 may be any suitable wired or wireless network, or combination of wired or wireless networks. For example, in some embodiments, network 102 may include a local area network (LAN), wide area network (WAN), a public switch telephone network (PSTN), and/or the Internet. Generally, network 102 may serve to electronically connect two or more components of system 100, or two or more computers, electronic terminals, databases, servers, devices, user interfaces, or other electronic aspects of one or more components of system 100. Any part of system 100 may be connected directly to another (e.g., via a wired or wireless connection) over network 102, or may be connected indirectly via one or more intermediary servers, computers, LANs, WANs, routers, etc. to another part or parts of system 100. In some embodiments, network 102 may be simply a plurality of electronic connections between devices, servers, and the like.

In some embodiments, two or more components of system 100 may share a physical location. For example, server system 110 may be located within, e.g., an account institution 108. In some embodiments, each account institution 108 and/or service provider 112 may include a server system 110. One or more users 106 may be located in the same geographic location (e.g., in the same room, at the same address, or in the same city, state, province, or country).

Customer 104 may be an individual or an entity having a device suitable for connecting to other components of system 100 via network 102. In some embodiments, customer 104 may be a person. In further embodiments, customer 104 may be, e.g., an institution (such as an educational institution, a nonprofit organization, etc.) or a company. Customer 104 may be a customer of, e.g., one or more of account institutions 108 and/or service providers 112. In some embodiments, customer 104 may be enrolled in one or more programs, rosters, account types, services, etc. in an account institution 108 or a service provider 112. In some embodiments, for example, customer 104 may be enrolled in a loan repayment program at an account institution 108. In further embodiments, customer 104 may hold a financial account at an account institution 108. In some embodiments, customer 104 may have multiple accounts at one or more of account institutions 108 or service providers 112.

Users 106 may be additional individuals or entities having devices suitable for connecting to other components of system 100 via network 102. In some embodiments, users 106 may be individual people. In further embodiments, users 106 may be, e.g., institutions (such as educational institutions, nonprofit organizations, etc.) or companies. In some embodiments, users 106 may include a mix of individuals and institutions or other entities. Some of users 106 may be customers, similar to customer 104. As with customer 104, users 106 may be customers of, e.g., one or more of account institutions 108 and/or service providers 112. Users 106 may be enrolled in programs, rosters, account types, services, etc. in account institutions 108 and/or service providers 112. For example, in some embodiments, one or more of users 106 may have multiple accounts at one or more of account institutions 108 or service providers 112. One or more of users 106 may share some characteristics with customer 104, such as account types, demographic information, financial needs or patterns, and the like. In some embodiments, users 106 may share information about their characteristics with, e.g., account institutions 108 over network 102.

Account institutions 108 may be any entities or organizations offering accounts to customers or users (e.g., customer 104 and/or users 106). An account may be any type of account directly or indirectly related to a user's finances. Examples include bank accounts, investment accounts, loan accounts (e.g., for student loans, mortgages, or other loans), credit accounts, or accounts for managing regular payments (e.g., student or tuition accounts, leases, etc.). In some embodiments, account institutions 108 may include one or more servers or server systems storing the details of accounts associated with customer 104 and/or users 106. Such servers or server systems may be connected to other aspects of system 100 via one or more connections, such as via network 102.

Server system 110 may comprise one or more computers, and may be configured to house databases or other electronic storage systems. Further, server system 110 may be configured to store and/or execute one or more functions, algorithms, or manipulations of data housed within it or transferred to it. In some embodiments, server system 110 may receive and send data via, e.g., network 102, and may store, manipulate, or perform calculations using such data. Server system 110 may also be configured or authorized to access, send, retrieve, or manipulate data from other aspects of system 100, such as from account institutions 108 or service providers 112. For example, in some embodiments, server system 110 may be authorized to access secure data pertaining to one or more digital accounts associated with one or more account institutions 108. In some embodiments, server system 110 may house one or more machine learning algorithms and may execute such algorithms according to methods of the present disclosure. While one server system 110 is depicted in FIG. 1, it is contemplated that, in some aspects, multiple server systems 110 may be a part of systems of the present disclosure and/or may execute methods of the present disclosure in concert.

Service providers 112 may include any institutions, businesses, individuals, or organizations providing services to, e.g., users within system 100 (e.g., users 106 and/or customer 104). Examples of service providers 112 may include medical service providers (e.g., hospitals, doctors, surgical centers, diagnostics laboratories, emergency responders, etc.) In some embodiments, service providers 112 may require payments from a customer 104 in exchange for services performed. In some embodiments, a service provider 112 may be associated with an account institution 108, such that users (e.g., users 106) may hold accounts (e.g., loan accounts, bank accounts, debit accounts, etc.) for sending or receiving payments to or from service provider 112. In some embodiments, account institutions 108 may include one or more servers or server systems storing the details of services rendered to customer 104 and/or users 106. Such servers or server systems may be connected to other aspects of system 100 via one or more connections, such as via network 102.

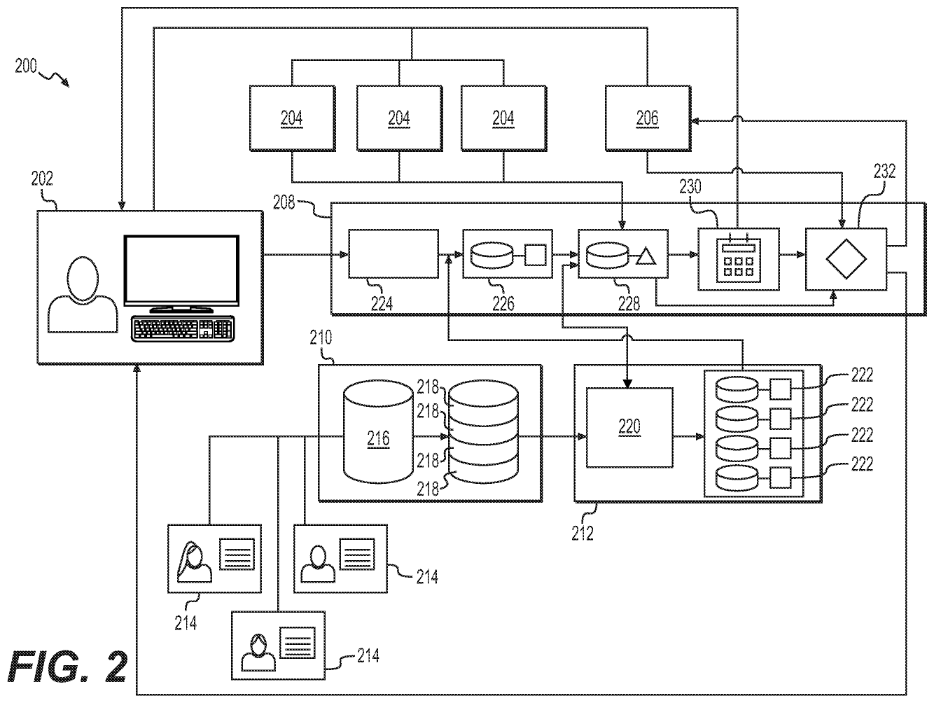

FIG. 2 illustrates a process flow 200 according to aspects of the present disclosure. Process flow 200 includes various modules, which may perform a plurality of functions to achieve one or more goals of the present disclosure. Process flow 200 includes a user interface 202, a plurality of accounts 204 for a user, a repayment account 206, a primary process module 208, a grouping module 210, a machine learning module 212, and customer information 214.

In some embodiments, process flow 200 may be located on or may be performed by various aspects of system 100, such as a device of customer 104 (e.g., user interface 202), one or more computers or servers of account institutions 108, and/or one or more computers or servers of service providers 112. In some embodiments, process flow 200 may be located on or may be performed entirely or in part by or on, e.g., a server system, such as server system 110. As is described in further detail below, in some embodiments, any given module of process flow 200 (e.g., primary process module 208, grouping module 210, and machine learning module 212) may be located on or performed by a single computer (e.g., a computer of server system 110). In some embodiments, more than one or all modules of process flow 200 may be located on or performed by a single computer, while in other embodiments, one or more modules or parts of modules may be located on or performed by a different computer. In such embodiments, each different computer may be connected to the other(s) by a wired or wireless connection (e.g., a local network or a wide-area network, as described elsewhere herein).

User interface 202 may include any user interface with which a user (e.g., a customer 104, a representative of an account institution 108 or a service provider 112, or other user) may interact, and which may send data to and/or receive data from the modules of process flow 200. User interface 202 may include any suitable device for receiving information from and/or providing information to a user. In some embodiments, for example, user interface 202 may include a computer having a screen, such as a personal computer, a smartphone, a tablet, or another such device. In some embodiments, user interface 202 may include alternative methods of communication to a user (e.g., audio, tactile feedback, and the like). In some embodiments, user interface 202 may be located remotely from (e.g., in a different geographic location from) the modules of process flow 200, and user interface 202 may be connected to the modules and other components of process flow 200 via a wired or wireless connection (e.g., via network 102). In some embodiments, user interface 202 may receive data about a customer (e.g., customer 104) and may send the data to, e.g., one or more modules of process flow 200. In some embodiments, user interface 202 may be configured to receive data, notifications, or other information from other components of process flow 200 and display it to the user of user interface 202.

Accounts 204 each may be an account in the name of a user (e.g., customer 104) interacting with user interface 202. While three accounts 204 are depicted as a part of process flow 200, it is contemplated that a user may be associated with more or fewer accounts. In some embodiments, one or more of accounts 204 may be an account managed or hosted by an account institution (e.g., an account institution 108). In some embodiments, one or more of accounts 204 may be an account held by the user with a service provider (e.g., a service provider 112). Examples of accounts include, e.g., bank accounts, credit accounts, debit accounts, loan repayment accounts, investment accounts, tuition accounts, and the like. Generally, the number and types of accounts associated with a user may depend on characteristics or preferences of the user, such as the user's lifestyle, selections, spending habits, employment, education, location/geographic region of residence, travel habits, and the like. Accounts 204 may be digitally-stored accounts in the system of, e.g., an account institution (e.g., account institution 108) or a service provider (e.g., service provider 112). In some embodiments, access to accounts 204 (e.g., by a user or by automatic processes or modules, such as primary process module 208) may be controlled and/or restricted by, e.g., permissions set by the user, or by an account institution 208 or a service provider 112. Each account 204 may include information about the user in whose name the account is held. The information may vary depending on the type and purpose of the account. Additionally, information about the user may be gleaned from an account 204; for example, a type of transaction or action reflected by an account (e.g., a purchase, a sale, a recurring transfer of funds, a change in balance, an enrollment, etc.) may provide information about a user and may be used to identify characteristics of the user (e.g., demographic information, such as age, location, sex, or income, liquidity, spending trends, etc.).

Repayment account 206 may be an account, such as an account 204, that specifically requires payment of funds by a user (e.g., a customer 104). Repayment account 206 may be, for example, a loan repayment account (e.g., a credit card loan or other loan), a credit account, or a mortgage). In some embodiments, repayment account 206 may be an account to which installments towards a purchase may be paid. In some embodiments, a user may wish to enroll in automatic periodic transfers of funds to repayment account 206. In some embodiments, a user may wish to have assistance in determining a recommended amount to pay towards repayment account 206 on a periodic basis. In some embodiments, repayment account 206 may be identified by a user (e.g., a customer 104 or other user) via a user interface (e.g., user interface 202). In some embodiments, for example, user interface 202 may display a plurality of accounts (e.g., including accounts 204 and repayment account 206), and a user may select repayment account 206 to identify it as such. In further embodiments, a user interface (e.g., user interface 202) may display to a user a suggestion that repayment account 206 may be a suitable account towards which automatic transfers of funds may be made. In some embodiments, such a suggestion may be made by, e.g., an account institution 108 or a service provider 112. In some embodiments, such a suggestion may be made by another part of process flow 200, such as, e.g., a part of primary process module 208.

Primary process module 208 may include a group of functions stored on a computer (e.g., server system 110, or a computer of an account institution 108 or service provider 112), or multiple computers, either in one or multiple locations, configured to determine and apply automatic periodic payments towards repayment account 206 from another account 204 of a user (e.g., customer 104). In some embodiments, for example, primary process module 208 may include one or more algorithms configured to send and receive information from machine learning module 212, accounts 204, repayment account 206, user interface 202, and/or other sources in order to determine and apply automatic period payments. As described in further detail below, primary process module 208 may include multiple steps, each of which may be performed by one or more functions, and each of which may return values to other modules and/or to user interface 202. In some embodiments, a computer running primary process module 208 may be authorized to access one or more accounts 204 and repayment account 206 to, e.g., determine information about a customer (e.g., customer 104) from accounts 204, and/or to make payments from one or more of accounts 204 towards repayment account 206 once an automatic payment amount has been determined.

Grouping module 210 may include a group of functions and/or computer storage on a computer (e.g., server system 110, or a computer of an account institution 108 or service provider 112) or multiple computers, either in one or multiple locations, configured to obtain data from customer information 214 and form customers into groups based on the obtained data. The obtained data may include, for example, characteristics of customers whose information is included in customer information 214. Grouping module 210 may include, for example, predetermined defined characteristics, or may include programming to automatically identify characteristics based on commonalities between customers. Formation of a group of customers by grouping module 210 may be based on a single shared characteristic, or may be based on multiple characteristics. Groupings of customers, and identification of their shared characteristics, may be stored in a data repository (e.g., a database), either local to grouping module 210 or remotely (e.g., in a remote database, in cloud storage, etc.).

Examples of characteristics are disclosed elsewhere herein. A non-exhaustive list of exemplary characteristics based on which customers may be grouped includes, e.g., demographic information (income brackets, net worth brackets, age, location, sex, employment, education), lifestyle, financial needs or patterns, spending habits or trends (e.g., payments to a particular type of institution or service provider 112), types of accounts associated with the customer, liquidity, savings, investments, risk-taking behaviors, and the like.

Machine learning module 212 may include a group of functions and/or computer storage on a computer (e.g., server system 110, or a computer of an account institution 108 or service provider 112) or multiple computers, either in one or multiple locations, configured to use data from, e.g., grouping module 210 and/or primary process module 208 to train a machine learning model. The machine learning model may be trained to, e.g., predict financial behavior based on grouped customers and their associated customer information 214. The machine learning model may also be tuned based on data from a particular customer (e.g., customer 104) and associated information, such as accounts 204, repayment account 206, and/or information received from user interface 202. In some embodiments, training of a machine learning model may be updated to account for, e.g., new customer information 214 and/or more updated data from a particular customer (e.g., customer 104). In some embodiments, for example, machine learning module 212 may be prompted to train or tune a machine learning model by primary process module 208. A machine learning model generated, trained, and/or tuned by machine learning module 212 may be any suitable model. In some embodiments, for example, the machine learning model may include a neural network, such as a recurring neural network or a convolutional neural network.

Financial behavior predicted by machine learning models may include, e.g., predicted income and expenditures over a period of time, such as between about one month and about three years, between about one month and two years, between about one month and six months, between about one month and three months, about a month, about six weeks, about three months, about six months, about nine months, about one year, about two years, about three years, or more. Predicted financial behavior may include predictions as to recurring periodic expenditures and income, and predictions as to less frequent, non-recurring expenditures and income, such as emergency expenditures, potential fluctuations in income, seasonal changes in spending patterns, higher points of expenditures at certain times of year, and the like. In some embodiments, predicted financial behavior may include predictions as to how and why income and expenditures are expected to be made.

Customer information 214 may include any information or data about a plurality of customers or users (e.g., users 106). In some embodiments, customer information 214 may be obtained from customers of, e.g., an account institution 108 and/or a service provider 112. In some embodiments, customers may consent before their information may be obtained and used. In some embodiments, customer information may be anonymized before it is used by, e.g., grouping module 210 and/or machine learning module 212. Customer information may include, e.g., customer demographic information (income brackets, net worth brackets, age, location, sex, employment, education, etc.), account types, account balances, statements, statement balances, income and/or spending patterns, and the like. In general, customer information 214 may include any data useful to, e.g., predict financial behavior of customers based on shared characteristics of the customers.

A progression through process flow 200 will now be described. It will be understood by one of ordinary skill in the art that this progression is merely exemplary, and that multiple permutations of progression through process flow 200 are possible that include additional steps, duplicate steps, and/or remove steps entirely. Moreover, although some interactions between modules and steps are depicted (by lines between such modules and steps) in FIG. 2, it is to be understood that such interactions are exemplary and that other interactions are also possible (e.g., between grouping module 210 and primary process module 208, between grouping module 210 and accounts 204, etc.)

Customer information 214 may be stored in, e.g., a repository 216. Grouping module 210 may group customer information 214 into a plurality of groups 218 based on shared characteristics of customers (e.g., users 106). Machine learning module 212 may generate and/or train a machine learning model 220 to generate a predicted financial behavior 222 for each group 218.

A request 224 may be received at process module 208 from a user interface 202 to apply automatic payments to a repayment account 206 on behalf of a customer (e.g., customer 104). The customer may be enrolled in, or may be requesting to be enrolled in, an automatic payments program, and/or another program at an account institution (e.g., an account institution 108) or a service provider (e.g., a service provider 112). Request 224 may include identifying information, such as an identity of a customer, identification of repayment account 206, and information identifying a plurality of accounts 204 associated with the customer. Identifying information may also include characteristics of the customer determined from, e.g., accounts 204, and may also include financial behavior, such as common expenditures, frequency of expenditures, times and places where money is spent or earned, liquidity, demographic information, etc. In a group selection step 226, process module 208 may retrieve information identifying groups of customers created by grouping module 210 and processed by machine learning model 220 to generate predicted financial behavior 222, and may select a group into which the customer may fit, based on identifying information of the customer (e.g., a characteristic or multiple characteristics). Machine learning model 220, trained by machine learning module 212 using the selected group, may generate predicted financial behavior (shown in step 226) for the customer.

In a tuning step 228, primary process module 208 may direct machine learning module 212 to tune machine learning model 220 using actual financial behavior of the customer. Actual financial behavior of the customer may come from, e.g., accounts 204 of the customer, or from other sources (e.g., the identifying information provided in request 224). Advantageously, tuned machine learning model 220 may rely both on groups 218 generated by grouping module 210 and on actual financial behavior of the customer, to arrive at more accurate predictions of financial behavior of the customer in the future.

In a simulation step 230, primary process module 208 may generate a predictive simulation of a financial situation for the customer, based on the trained/tuned machine learning model 220. The predictive simulation of a financial situation may be based on a hypothetical future point in time, such as about one month, about six weeks, about three months, about six months, about nine months, or about a year in the future. The predictive simulation may be any suitable simulation configured to test potential situations for the customer. In some embodiments, potential situations may depend on, e.g., identifying information or characteristics of the customer. For example, an age, location, or income bracket of the customer may inform the types of financial situations the customer may encounter. In some embodiments, the predictive simulation may include situations configured to stress financial resources of the customer (e.g., unexpectedly large expenditures due to a trigger event such as a medical event requiring expenditures, unexpected travel, a family emergency or other emergency, a birth, a death, new liabilities, a career change, and the like). In some embodiments, the simulation step 230 may include running multiple predictive simulations to test multiple different potential future simulations for a customer.

In some embodiments, predictive simulations generated by primary process module 208 may result in information being returned to user interface 202, or to the customer via other means. For example, in some embodiments, a predictive simulation may be configured to generate an alert if an outcome of the simulation is negative (e.g., resulting in unmanageable debt, an inability to make payments towards repayment account 206, or the like). An alert may include a visual or other cue generated on user interface 202, a message sent to user interface 202, and/or a message sent to the customer. In some embodiments, a predictive simulation may be configured to generate information for a customer if an outcome of the simulation shows that the customer may be eligible for certain processes, benefits, programs, and the like. For example, a predictive simulation may show that the customer is a potential candidate for a new credit account, a new bank account, a loan refinancing, or other program.

In some embodiments, simulation step 230 may be skipped by primary processing module 208. For example, if simulations have previously been run, or if simulations are deemed to be unnecessary, then simulation step 230 may be bypassed.

According to step 232, a payment may be calculated and scheduled. For example, the calculated payment may be an automatic periodic (or one-time) payment scheduled to be made to repayment account 206 from another account belonging to the customer (e.g., an account 204, either selected by the customer or identified by primary process module 208). The calculated payment may take into account any and/or all parts of process flow 200. For example, in some embodiments, the calculated payment may take into account the trained/tuned machine learning model 220 and predicted financial behavior of the customer (per step 226). In some embodiments, the calculated payment may be adjusted upwards or downwards based on the predictive simulation (e.g., if a predictive simulation shows that the customer will be well-equipped to deal with a trigger event in the future, then the calculated payment may be adjusted upwards, but if a predictive simulation shows that the customer may encounter financial stress due to a potential trigger event, then the calculated payment may be adjusted downwards). Additionally or alternatively, a timing for the calculated payment (e.g., a payment interval, period, date, or time) similarly may be adjusted based on the predictive simulation.

The payment (including an amount paid and/or a timing of the payment) may be specifically calculated to provide certain benefits. For example, the payment may be calculated to maximize the speed at which repayments are made to repayment account 206, while minimizing risk to the customer. This may benefit the customer, as well as the entity to which repayments are due.

In some embodiments, information about the calculated payment may be returned to, e.g., user interface 202. In some embodiments, the payment, once calculated, may be automatically scheduled and made to repayment account 206.

In some embodiments, as a part of process flow 200, the payment (e.g., the amount paid or the timing of the payment) towards repayment account 206 may be recalculated, either periodically or based on an event. For example, a customer may request that the payment be recalculated, or the payment may be recalculated periodically (e.g., about every month, every two months, every three months, every 6 months, annually, etc.). In some embodiments, financial information of the customer may be tracked, e.g., by primary process module 208, or a user may input new information about the customer into primary process module 208, which may cause the payment and/or its timing to be recalculated. In some embodiments, new customer information 214 may be provided to grouping module 210, or machine learning module 212 may be refined, which may cause the payment and/or its timing to be recalculated.

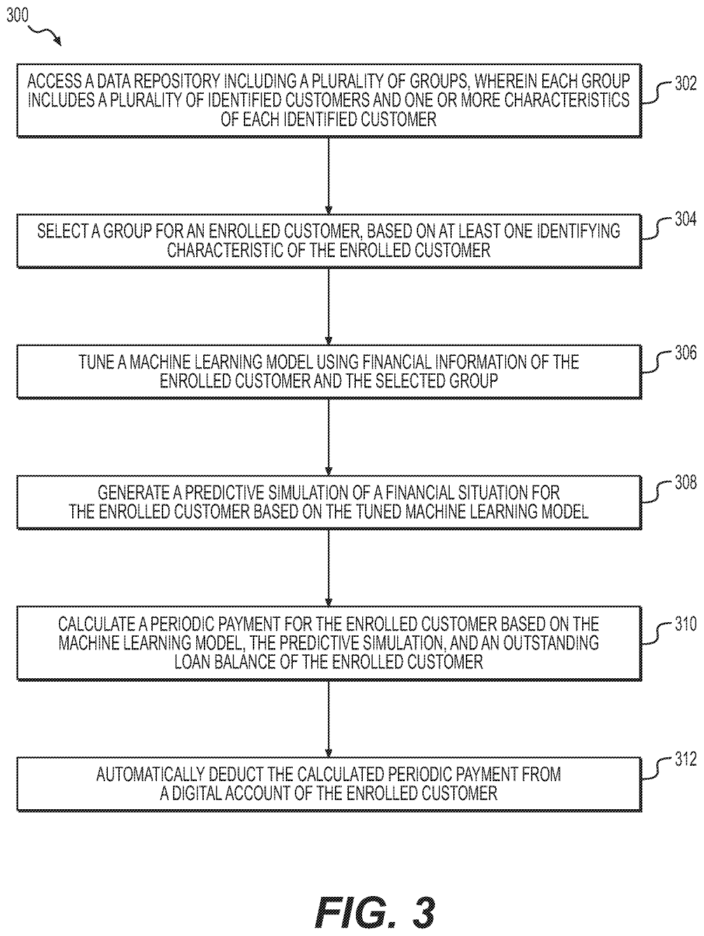

FIGS. 3, 4, and 5 illustrate, in flow chart form, steps in methods according to aspects of the present disclosure. These methods may be performed within, e.g., system 100 (or other suitable systems), and/or as a part of process flow 200. Aspects of system 100 and process flow 200 are applicable to these methods, and as such those aspects will not be re-described in detail below. In some embodiments, these methods may represent parts of, or permutations of, process flow 200. The steps shown in each method may be performed consecutively as a part of a single method, or may be performed independently from one another. Additionally, while FIGS. 3, 4, and 5 each illustrate an exemplary order of steps, it is contemplated that steps may be added, removed, and/or performed in an order different from the illustrated order.

FIG. 3 depicts steps in an exemplary method 300 for managing an account using a machine learning model. According to step 302, a data repository may be accessed, the data repository including a plurality of groups (e.g., groups 218). Each group may include a plurality of identified customers and one or more characteristics of each identified customer. According to step 304, a group for an enrolled customer may be selected based on at least one identifying characteristic of the enrolled customer (e.g., group selection step 226). According to step 306, a machine learning model (e.g., machine learning model 220) may be tuned using financial information of the enrolled customer and the selected group. According to step 308, a predictive simulation of a financial situation for the enrolled customer may be generated, based on the tuned machine learning model (e.g., simulation step 230). According to step 310, a periodic payment (e.g., an amount, a timing, and/or a payment interval) for the enrolled customer may be calculated based on the machine learning model, the predictive simulation, and an outstanding loan balance (e.g., in repayment account 206) of the enrolled customer (e.g., payment calculation step 232). According to step 312, the calculated periodic payment may be automatically deducted from a digital account of the enrolled customer (e.g., an account 204 of the customer).

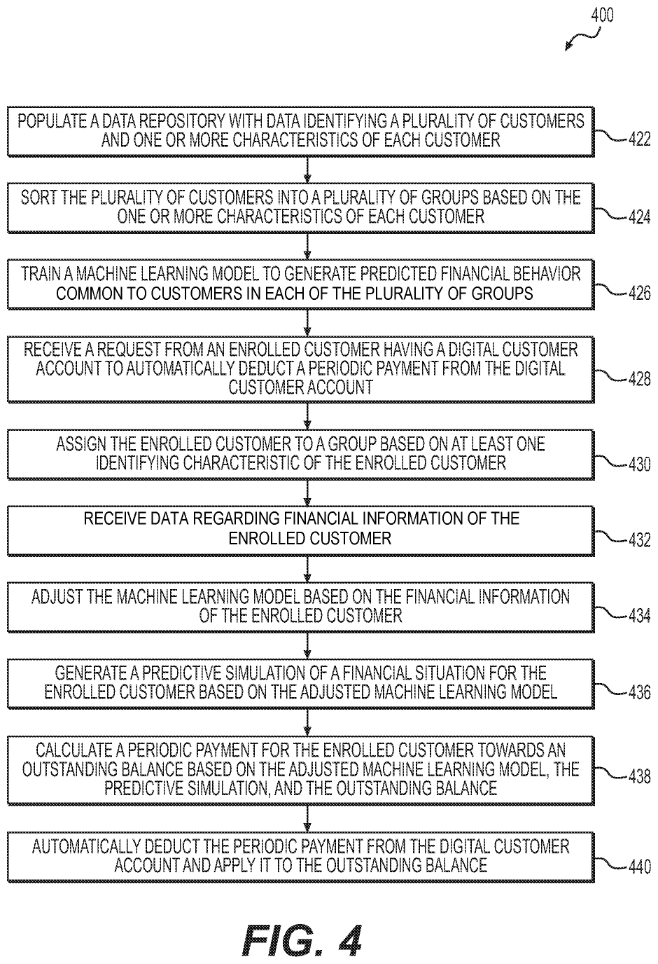

FIG. 4 depicts steps in an exemplary method 400 for training a machine learning model (e.g., machine learning model 220) and managing an account using the machine learning model. According to step 422, a data repository (e.g., data repository 216) may be populated with data identifying a plurality of customers and one or more characteristics of each customer. According to step 424, the plurality of customers may be sorted into a plurality of groups (e.g., groups 218), based on the one or more characteristics of each customer. According to step 426, a machine learning model (e.g., machine learning model 220) may be trained to generate predicted financial behavior (e.g., predicted financial behavior 222) common to customers in each of the plurality of groups. According to step 428, a request (e.g., request 224) may be received from an enrolled customer (e.g., customer 104) having a digital customer account (e.g., an account 204) to automatically deduct a periodic payment from the digital customer account (e.g., towards a repayment account 206). According to step 430, the enrolled customer may be assigned to a group based on at least one identifying characteristic of the enrolled customer (e.g., group selection step 226). According to step 432, data regarding financial information of the enrolled customer may be received (e.g., from accounts 204 and/or request 224). According to step 434, the machine learning model may be adjusted based on the financial information of the enrolled customer (e.g., tuning step 228). According to step 436, a predictive simulation of a financial situation for the enrolled customer based on the adjusted machine learning model may be generated (e.g., simulation step 230). According to step 438, a periodic payment (e.g., an amount, a timing, and/or a payment interval) for the enrolled customer towards an outstanding balance may be calculated, based on the adjusted machine learning model, the predictive simulation, and the outstanding balance (e.g., payment calculation step 232). According to step 440, the periodic payment from the digital customer account may be automatically deducted and applied to the outstanding balance (e.g., in repayment account 206).

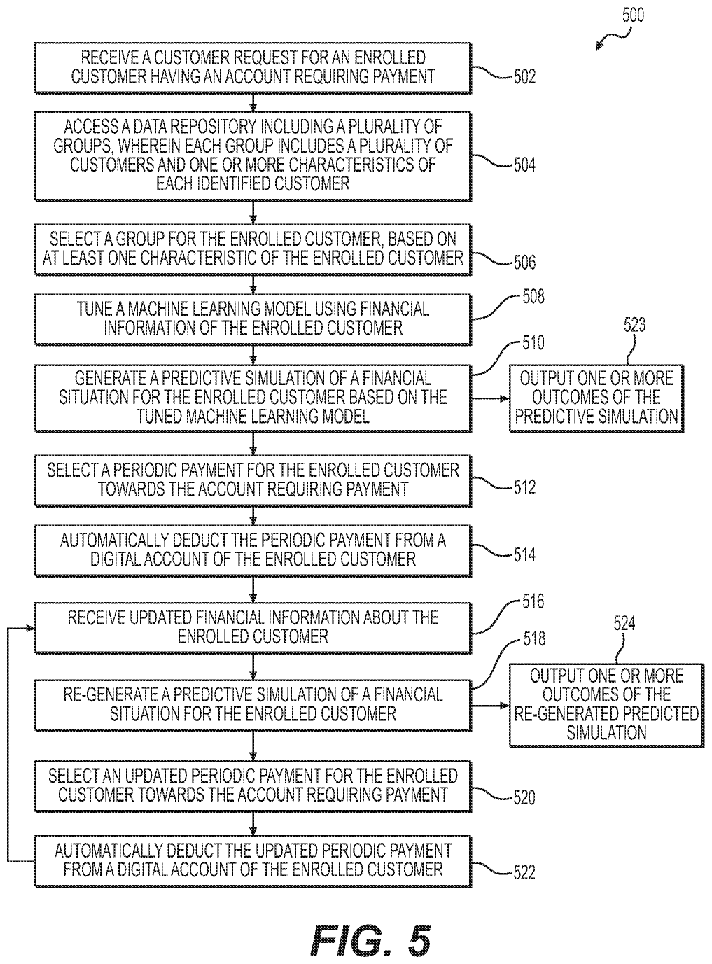

Referring now to FIG. 5, steps are depicted in a method 500 for tuning a machine learning model (e.g., machine learning model 220), to dynamically manage an account using the machine learning model. According to step 502, a customer request (e.g., request 224) may be received for an enrolled customer (e.g., customer 104, enrolled in, e.g., a program at an account institution 108) having an account requiring payment (e.g., repayment account 206). According to step 504, a data repository including a plurality of groups may be accessed (e.g., repository 216, divided into groups 218). Each group may include a plurality of customers and one or more characteristics of each identified customer. According to step 506, a group may be selected for the enrolled customer, based on at least one characteristic of the enrolled customer (e.g., group selection step 226). According to step 508, a machine learning model (e.g., machine learning model 220) may be tuned using financial information of the enrolled customer (e.g., from accounts 204 and/or from identifying information transferred in request 224). According to step 510, a predictive simulation of a financial situation for the enrolled customer may be generated, based on the tuned machine learning model (e.g., simulation step 230). According to step 512, a periodic payment (e.g., an amount, a timing, and/or a payment interval) towards the account requiring payment may be selected for the enrolled customer (e.g., according to payment calculation step 232). According to step 514, the periodic payment may be automatically deducted from a digital account (e.g., an account 204) of the enrolled customer.

According to step 516, updated financial information about the enrolled customer may be received. This may be received from, e.g., an updated request, such as a request 224, or may be automatically retrieved from, e.g., an account 204 or repayment account 206 of the customer. For example, updated financial information about the enrolled customer may be periodically retrieved. The updated financial information may include, e.g., a balance over a particular threshold, a new income source, a reduced or removed income source, a new expenditure over a given threshold, an added account (e.g., a new account 204), a closed account, or any other updated information about the enrolled customer. According to step 518, a predictive simulation of a financial situation for the enrolled customer may be re-generated (e.g., according to simulation step 230), using the updated financial information. In some embodiments, this may optionally include re-tuning the machine learning model to better reflect new actual financial behavior of the enrolled customer. Upon generating or re-generating a predictive simulation, according to steps 523 and 524, one or more outcomes of the predictive simulation or the re-generated predictive simulation may be output to, e.g., the enrolled customer (e.g., via a message to the enrolled customer, and/or as an output to a user interface such as user interface 202). According to step 520, an updated periodic payment towards the account requiring payment (e.g., an updated amount, schedule, payment interval, etc.) may be selected based on, e.g., the updated financial information and the re-generated predictive simulation of a financial situation for the enrolled customer. According to step 522, the updated periodic payment may be automatically deducted from a digital account of the enrolled customer. Steps 516, 518, 520, and 522 may be performed recursively to, e.g., dynamically determine and deduct an updated periodic payment over time.

In general, any process or method discussed in this disclosure that is understood to be performable by a computer may be performed by one or more processors. Such processors may be located in, for example, one or more of the components of system 100, depicted in FIG. 1, and/or one or more of the components of process flow 200, depicted in FIG. 2. The one or more processors may be configured to perform the processes or methods disclosed herein by instructions (computer-readable code) that, when executed by the processors, cause the one or more processors to perform the processes. The instructions also may be stored on a non-transitory computer-readable medium.

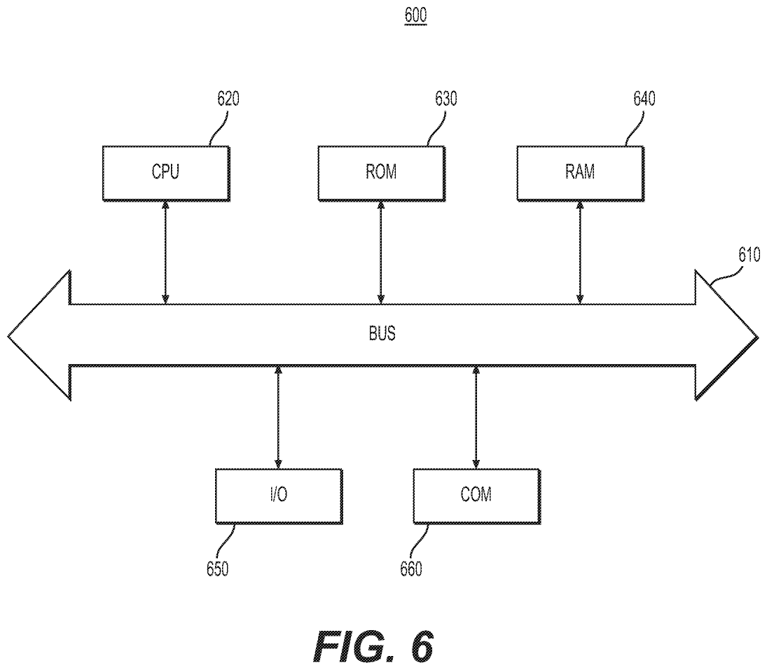

FIG. 6 is a simplified functional block diagram of a computer that may be configured to execute techniques described herein, according to exemplary embodiments of the present disclosure. Specifically, the computer (or “platform” as it may not a be a single physical computer infrastructure) may include a data communication interface 660 for packet data communication. The platform also may include a central processing unit (“CPU”) 620, in the form of one or more processors, for executing program instructions. The platform may include an internal communication bus 610, and the platform also may include a program storage and/or a data storage for various data files to be processed and/or communicated by the platform such as ROM 630 and RAM 640, although the system 600 may receive programming and data via network communications. The system 600 also may include input and output ports 650 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

In the above description, various aspects of the disclosed systems and methods are sometimes grouped together in a single embodiment, figure, or description thereof for the purpose of streamlining the disclosure and aiding in the understanding of one or more of the various inventive aspects. This is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, combinations of features of different embodiments disclosed herein are intended to be within the scope of the present disclosure, as would be understood by those skilled in the art. Thus, while certain embodiments have been described, those skilled in the art will recognize that other and further modifications may be made thereto without departing from the spirit of the invention. For example, functionality may be added or deleted from the block diagrams and flow charts provided herewith. Moreover, steps of the methods disclosed herein may be added, deleted, or performed out of their depicted order.

The above disclosed subject matter is to be considered illustrative, and not restrictive, and the appended claims are intended to cover all modifications, enhancements, and implementations that fall within the true spirit and scope of the present disclosure. Thus, to the maximum extent allowed by law, the scope of the claims is to be determined by their broadest permissible interpretation. While various implementations of the disclosure have been described, it will be apparent to those of ordinary skill in the art that many more implementations are possible within the scope of the disclosure.

1. A computer-implemented method of deducting funds from a digital account, the method comprising:
accessing a data repository including a plurality of groups, wherein each group includes a plurality of identified customers and one or more characteristics of each identified customer;
selecting a group for an enrolled customer, based on at least one identifying characteristic of the enrolled customer;
training a machine learning model using financial behavior of the enrolled customer and the selected group, wherein the financial behavior includes data indicative of income and expenditures of the enrolled customer and the selected group;
generating a predictive simulation for the enrolled customer using the trained machine learning model by:
determining a situation type of a potential trigger event based on the at least one identifying characteristic of the enrolled customer;
determining a time point of the potential trigger event based on the at least one identifying characteristic of the enrolled customer;
simulating the potential trigger event based on the situation type and the time point to stress a financial resource of the enrolled customer; and
determining of a corresponding future financial impact of the potential trigger event on the enrolled customer;
calculating a periodic payment for the enrolled customer based on the predictive simulation for the enrolled customer generated by the trained machine learning model and an outstanding loan balance of the enrolled customer; and
automatically deducting the calculated periodic payment from the digital account of the enrolled customer.

2. The computer-implemented method of claim 1, wherein the financial behavior of the enrolled customer includes one of:
a spending habit of the enrolled customer; or
a purchase made by the enrolled customer.

3. (canceled)

4. The computer-implemented method of claim 1, further comprising:
predicting the future financial impact of the potential trigger event on the enrolled customer with the time point including at least three months.

5. The computer-implemented method of claim 1, further comprising:
automatically applying the periodic payment deducted from the digital account of the enrolled customer to an account requiring payment.

6. The computer-implemented method of claim 5, wherein the account requiring payment is a loan repayment account.

7. The computer-implemented method of claim 5, further comprising:
after automatically deducting the calculated periodic payment from the digital account of the enrolled customer, receiving new financial behavior of the enrolled customer;
recalculating a periodic payment for the enrolled customer based on the new financial behavior;
automatically deducting the recalculated periodic payment from the digital account of the enrolled customer; and
automatically applying the recalculated deducted periodic payment to a balance requiring payment.

8. The computer-implemented method of claim 1, wherein each of the plurality of groups includes customers having one or more characteristics in common with other customers in the group, and
wherein the one or more characteristics of each customer includes a transaction history pattern, a credit score range, an account balance range, an account type, a geographic location, an income range, or an age range.

9. (canceled)

10. A computer-implemented method of deducting funds from a digital account, the method comprising:
populating a data repository with data identifying a plurality of customers and one or more characteristics of each customer;
sorting the plurality of customers into a plurality of groups based on the one or more characteristics of each customer;
training a machine learning model using financial behavior of customers in each of the plurality of groups, wherein the financial behavior includes data indicative of income and expenditures of customers in each of the plurality of groups;
assigning an enrolled customer having a digital customer account to a group based on at least one identifying characteristic of the enrolled customer;
tuning the trained machine learning model using actual financial behavior of the enrolled customer;
generating a predictive simulation for the enrolled customer using the tuned machine learning model by:
determining a situation type of a potential trigger event based on the at least one identifying characteristic of the enrolled customer;
determining a timing of the potential trigger event based on the at least one identifying characteristic of the enrolled customer;
simulating the potential trigger event based on the situation type and the timing to stress a financial resource of the enrolled customer; and
determining a corresponding future financial impact of the potential trigger event on the enrolled customer;
calculating a periodic payment for the enrolled customer towards an outstanding loan balance based on the predictive simulation for the enrolled customer and the outstanding loan balance; and
automatically deducting the periodic payment from the digital customer account and applying it to the outstanding loan balance.

11. The computer-implemented method of claim 10, wherein assigning the enrolled customer to the group includes identifying a commonality between the at least one identified characteristic of the enrolled customer and one or more characteristics of other customers in the group.

12. The computer-implemented method of claim 11, wherein the commonality includes one of a similar transaction history, a similar credit score, a similar average account balance, an account type, a similar geographic location, a similar income, or a similar age.

13. The computer-implemented method of claim 10, wherein the at least one identifying characteristic of the enrolled customer includes a transaction history.

14. The computer-implemented method of claim 10, further comprising:
receiving a request from the enrolled customer to calculate the periodic payment for the enrolled customer towards the outstanding loan balance.

15. The computer-implemented method of claim 10, further comprising:
receiving information regarding a trigger event for the enrolled customer; and
automatically recalculating a periodic payment for the enrolled customer towards the outstanding loan balance, based on the trigger event.

16. The computer-implemented method of claim 10,
wherein the potential trigger event includes:
an unexpected decrease in funds in the digital customer account; or
an unexpected requirement for more funds from the digital customer account from a third party.

17. The computer-implemented method of claim 10, wherein predicted financial behavior common to customers in at least one of the plurality of groups in response to the potential trigger event includes predicted financial behavior based on a time of year.

18. The computer-implemented method of claim 10, further comprising:
receiving information regarding a trigger event for the enrolled customer;
automatically recalculating a periodic payment for the enrolled customer towards the outstanding loan balance; and
sending a message to the enrolled customer describing the trigger event and the recalculated periodic payment.

19. The computer-implemented method of claim 10, wherein the step of sorting the plurality of customers into the plurality of groups based on the one or more characteristics of each customer includes executing an unsupervised clustering algorithm.

20. A non-transitory computer-readable medium storing instructions that, when executed by one or more processors of a computer system, cause the one or more processors to perform operations comprising:
populating a data repository with a plurality of groups, a plurality of customers associated with each of the plurality of groups, and one or more characteristics of each customer;
training a machine learning model using the data repository;
assigning an enrolled customer having a digital customer account to a group based on at least one identifying characteristic of the enrolled customer;
tuning the trained machine learning model using actual financial behavior of the enrolled customer, wherein the financial behavior includes data indicative of income and expenditures of the enrolled customer and the group;
using the tuned machine learning model to:
determine a situation type and a time point of a potential trigger event based on the at least one identifying characteristic of the enrolled customer;
simulating the potential trigger event based on the situation type and the time point to stress a financial resource of the enrolled customer; and
determine a financial impact of the potential trigger event on the enrolled customer;
calculating a periodic payment for the enrolled customer towards an outstanding loan balance using the tuned machine learning model and based on the financial impact and the outstanding loan balance; and
automatically applying the period payment from the digital customer account to the outstanding loan balance.

21. The computer-implemented method of claim 1, wherein the situation type of the potential trigger event includes one of:
a medical event;
an unexpected travel event;
a family emergency event;
a birth event;
a death event; or
a professional career change.

22. The computer-implemented method of claim 1, wherein the time point of the potential trigger event is a future point in time that includes one of:
one or more days;
one or more weeks;
one or more months; or
one or more years.
